(19) United States
(12) Patent Application Publication
(10) Pub. No.: US 2022/0398431 A1
(43) Pub. Date: Dec. 15, 2022

(54) Distributed Deep Learning System and Data Transfer Method

(71) Applicant: Nippon Telegraph and Telephone Corporation, Tokyo (JP)

(72) Inventors: Kenji Tanaka, Tokyo (JP); Yuki Arikawa, Tokyo (JP); Kenji Kawai, Tokyo (JP); Junichi Kato, Tokyo (JP); Tsuyoshi Ito, Tokyo (JP); Huycu Ngo, Tokyo (JP); Takeshi Sakamoto, Tokyo (JP)

(21) Appl. No.: 17/775,549

(22) PCT Filed: Nov. 13, 2019
(86) PCT No.: PCT/JP2019/044529

§ 371 Date: May 9, 2022

(51) Int. Cl. G06N 3/04; G06N 3/08

(52) U.S. Cl. CPC G06N 3/04; G06N 3/084

(57) ABSTRACT

Provided is a distributed deep learning system including a plurality of distributed processing nodes, in which each of the plurality of distributed processing nodes includes a header reading unit configured to read pieces of layer information of headers of a first data frame that has arrived at an own node and a second data frame that has arrived next, and in which the pieces of layer information are compared with each other, calculation processing is executed for a data frame including data that belongs to a layer closer to an input layer, and calculation processing for a data frame including data that belongs to a layer closer to an output layer is skipped.

This patent application is a national phase filing under section 371 of PCT application no. PCT/JP2019/044529, filed on Nov. 13, 2019, which application is hereby incorporated herein by reference in its entirety.

### TECHNICAL FIELD

The present invention relates to a distributed deep learning system and a data transfer method, and more particularly, to the technology of transferring data in distributed deep learning that uses a plurality of distributed processing nodes operating in association with one another in a network.

### BACKGROUND

Hitherto, deep learning that causes a multi-layer neural network to learn a feature of data has been proposed. Deep learning performs learning using a larger amount of learning data to improve the accuracy of classification or prediction. In order to improve the efficiency of this learning processing, a distributed deep learning system that processes data in parallel is proposed, in which a plurality of distributed processing nodes cooperate with one another in a network and each distributed processing node learns different data.

In deep learning in the conventional distributed deep learning system, each of a plurality of computers forming the distributed deep learning system propagates pieces of learning data from an input layer to an output layer in order, and calculates a loss function serving as an indicator of the degree of deviation of an output value of a neural network from correct label data. The processing of calculating the output values in order from a layer on the input side of the neural network toward a layer on the output side of the neural network in this manner is called “forward propagation calculation”.

The conventional distributed deep learning system calculates a partial derivative (gradient) of the value of the loss function, which has been calculated by each distributed processing node through forward propagation calculation, with respect to each configuration parameter (for example, weight of neural network) of the neural network. The gradient with respect to the configuration parameter of each layer is calculated in order from a layer on the output side of the neural network toward a layer on the input side of the neural network, and thus this processing is called “backpropagation calculation”.

Meanwhile, a mini-batch method has hitherto been used as one technique for improving the estimation accuracy. The mini-batch method repeats gradient calculation processing of calculating a gradient with respect to a weight for each sample data indicating the result of forward propagation calculation, aggregation processing (adding up gradients obtained for respective pieces of sample data separately for each weight) of aggregating the gradients calculated for a plurality of different pieces of sample data, and weight update processing of updating each weight based on the aggregated gradient.

In this manner, in the conventional distributed deep learning system, collective communication (hereinafter referred to as “Allreduce processing”) that shares gradient information among distributed processing nodes and aggregates the gradient information is performed after the backpropagation calculation (for example, refer to NPL 1). In other words, in distributed deep learning, the processing of forward propagation calculation, backpropagation calculation, Allreduce processing, and forward propagation calculation is executed repeatedly to progress learning of a deep learning model.

The backpropagation calculation is finished in order from the output layer to the input layer, and the forward propagation calculation is started in order from the input layer to the output layer. Thus, in general, it is necessary to start the forward propagation calculation after waiting for the end of Allreduce processing. In the distributed deep learning system described in NPL 1, error backpropagation calculation and Allreduce processing are executed for each parameter of each layer of the deep learning model to enable suppression of the communication time through overlapping of processing.

### CITATION LIST

### Non Patent Literature

[NPL 1] K. Tanaka et al., “Distributed Deep Learning with FPGA Ring Allreduce” in Proceedings of International Supercomputing Conference, 2019/6.

### SUMMARY

### Technical Problem

However, in the conventional distributed deep learning system, backpropagation calculation and forward propagation calculation start to calculate data from different layers in distributed deep learning, and thus delay of processing sometimes occurs in the distributed processing node.

Embodiments of the present invention have been made in order to solve the above-mentioned problem, and has an object to suppress the delay of processing in a distributed processing node, and perform distributed deep learning more efficiently.

### Means for Solving the Problem

In order to solve the above-mentioned problem, a distributed deep learning system according to embodiments of the present invention is a distributed deep learning system, including a plurality of distributed processing nodes forming a ring communication network that enables communication in one direction, the distributed deep learning system being configured to perform forward propagation calculation and backpropagation calculation based on learning data of a neural network repetitively in a distributed manner in units of data frame, and perform collective communication of adding up calculation results of the backpropagation calculation, wherein each of the plurality of distributed processing nodes includes: a reception unit configured to sequentially receive, via the communication network, a first data frame that has arrived at an own node and a second data frame that has arrived at the own node subsequent to the first data frame; a header reading unit configured to read layer information included in a header of each of the first data frame and the second data frame received by the reception unit, which indicates which one of layers including an input layer, an intermediate layer, and an output layer of the neural network data included in each of the first data frame and the second data frame belongs to; a determination unit configured to compare the layer information read by the header reading unit from the first data frame received by the reception unit with the layer information read from the second data frame received subsequent to the first data frame, and determine which one of the input layer and the output layer a layer of data of each of the first data frame and the second data frame is closer to; a calculation unit configured to execute, based on a result of determination by the determination unit, calculation processing based on input of sample data indicating a result of forward propagation calculation of the neural network for a data frame including data that belongs to a layer closer to the input layer out of the first data frame and the second data frame; a transfer unit configured to skip, based on the result of determination by the determination unit, the calculation processing for a data frame including data that belongs to a layer closer to the output layer out of the first data frame and the second data frame; and a transmission unit configured to transmit, to a distributed processing node at a subsequent stage, the first data frame and the second data frame processed by the calculation unit or the transfer unit; wherein the transmission unit is configured to transmit, to the distributed processing node at a subsequent stage, a data frame for which the calculation processing has been skipped by the transfer unit before a data frame for which the calculation processing has been executed by the calculation unit out of the first data frame and the second data frame.

In order to solve the above-mentioned problem, a data transfer method according to the present invention is a data transfer method to be executed by a distributed deep learning system comprising a plurality of distributed processing nodes forming a ring communication network that enables communication in one direction, the distributed deep learning system being configured to perform forward propagation calculation and backpropagation calculation based on learning data of a neural network repetitively in a distributed manner in units of data frame, and perform collective communication of adding up calculation results of the backpropagation calculation, wherein the data transfer method includes: a first step of sequentially receiving, via the communication network, a first data frame that has arrived at an own node and a second data frame that has arrived at the own node subsequent to the first data frame; a second step of reading layer information included in a header of each of the first data frame and the second data frame received in the first step, which indicates which one of layers including an input layer, an intermediate layer, and an output layer of the neural network data included in each of the first data frame and the second data frame belongs to; a third step of comparing the layer information read in the second step from the first data frame received in the first step with the layer information read from the second data frame received subsequent to the first data frame, and determining which one of the input layer and the output layer a layer of data of each of the first data frame and the second data frame is closer to; a fourth step of executing, based on a result of determination in the third step by the determination unit, calculation processing based on input of sample data indicating a result of forward propagation calculation of the neural network for a data frame including data that belongs to a layer closer to the input layer out of the first data frame and the second data frame; a fifth step of skipping, based on the result of determination in the third step, the calculation processing for a data frame including data that belongs to a layer closer to the output layer out of the first data frame and the second data frame; and a sixth step of transmitting, to a distributed processing node at a subsequent stage, the first data frame and the second data frame processed in the fourth step or the fifth step; and wherein the sixth step comprises transmitting, to the distributed processing node at a subsequent stage, a data frame for which the calculation processing has been skipped in the fifth step before a data frame for which the calculation processing has been executed in the fourth step out of the first data frame and the second data frame.

### Effects of Embodiments of the Invention

According to embodiments of the present invention, pieces of layer information of headers of a first data frame that has arrived at an own node and a second data frame that has arrived next are compared with each other, calculation processing is executed for a data frame including data that belongs to a layer closer to an input layer, and calculation processing for a data frame including data that belongs to a layer closer to an output layer is skipped. Therefore, it is possible to suppress the delay of processing in a distributed processing node, and perform distributed deep learning processing more efficiently.

### BRIEF DESCRIPTION OF THE DRAWINGS

FIG. 1 is a block diagram illustrating a configuration of a distributed processing node according to a first embodiment of the present invention.

FIG. 2 is a block diagram illustrating an outline of a distributed deep learning system according to the first embodiment.

FIG. 3 is a schematic diagram illustrating a structure of a data frame according to the first embodiment.

FIG. 4 is a block diagram illustrating a configuration of a header reading unit according to the first embodiment.

FIG. 5 is a block diagram illustrating an example of a hardware configuration of the distributed processing node according to the first embodiment.

FIG. 6 is a flow chart for describing an operation of the distributed processing node according to the first embodiment.

FIG. 7 is a schematic diagram illustrating a structure of a data frame according to a second embodiment.

FIG. 8 is a schematic diagram illustrating a structure of a data frame according to a third embodiment.

FIG. 9 is a block diagram illustrating a configuration of a header reading unit according to the third embodiment.

FIG. 10 is a flow chart for describing an operation of a distributed processing node according to the third embodiment.

FIG. 11 is a flow chart for describing an operation of the distributed processing node according to the third embodiment.

FIG. 12 is a diagram for describing an operation of a distributed deep learning system according to the third embodiment.

FIG. 13 is a schematic diagram illustrating a structure of a data frame according to a fourth embodiment.

FIG. 14 is a block diagram illustrating a configuration of a distributed processing node according to the fourth embodiment.

### DETAILED DESCRIPTION OF ILLUSTRATIVE EMBODIMENTS

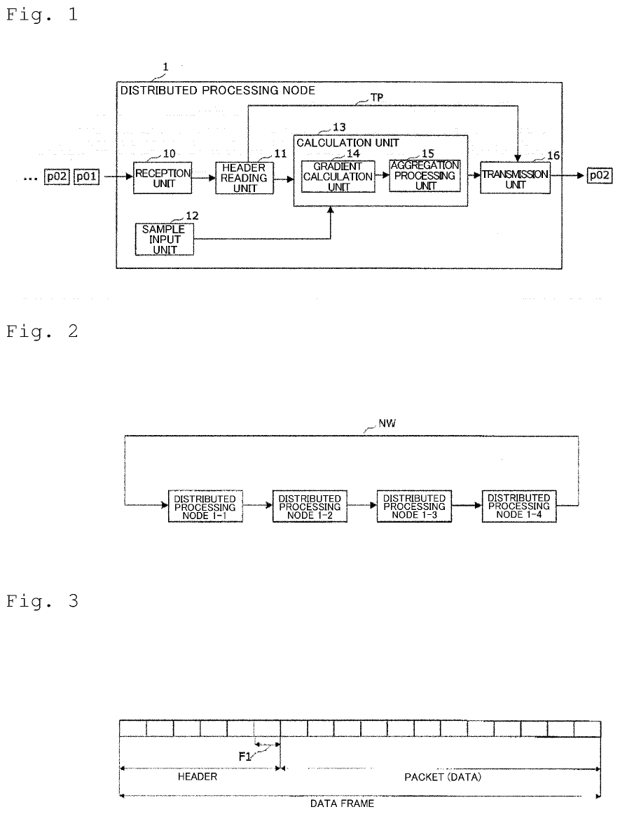

Now, description is given in detail of preferred embodiments of the present invention with reference to FIG. 1 to FIG. 14.

### First Embodiment

FIG. 1 is a block diagram illustrating a configuration of a distributed processing node 1 included in a distributed deep learning system according to a first embodiment of the present invention. FIG. 2 is a block diagram illustrating a configuration of the distributed deep learning system. In the distributed deep learning system according to this embodiment, forward propagation calculation and backpropagation calculation based on learning data of a multi-layer neural network including an input layer, an intermediate layer, and an output layer are divided into calculations in units of data frame and performed repetitively. Furthermore, in the distributed deep learning system, Allreduce processing of adding up the calculation results of backpropagation calculation is performed.

In this embodiment, the distributed deep learning system uses, for example, a mini-batch method to repeatedly perform gradient calculation processing of calculating a gradient with respect to a weight for each sample data indicating the calculation result of forward propagation calculation, aggregation processing, and weight update processing. The aggregation processing is aggregation processing of aggregating (adding up gradients obtained for respective pieces of sample data separately for each weight) the gradients for a plurality of different pieces of sample data. The weight update processing is weight update processing of updating each weight based on the aggregated gradient.

In the distributed deep learning system according to this embodiment, a data frame to be transmitted/received among the distributed processing nodes 1 stores, in its header, layer information indicating which layer of a neural network data of the data frame belongs to.

Each distributed processing node 1 includes a header reading unit 11 configured to read the header of a received data frame. Each distributed processing node 1 determines whether to perform calculation processing using the data by itself or to skip the calculation processing based on header information of received data.

In this manner, in this embodiment, each distributed processing node 1 first finishes calculation processing for data closer to an input layer while at the same time skipping unnecessary calculation. Thus, the distributed deep learning system according to this embodiment enables each distributed processing node 1 to perform calculation processing for data closer to the input layer of the neural network preferentially in the Allreduce processing of sharing data among processes.

As illustrated in FIG. 2, the distributed deep learning system according to this embodiment includes a plurality of distributed processing nodes 1-1 to 1-4 connected to one another via a communication network NW. The distributed processing nodes 1-1 to 1-4 form the ring communication network NW enabling transfer of data in one direction.

The distributed processing nodes 1-1 to 1-4 transfer data frames via the communication network NW such as Ethernet (registered network). Each of the distributed processing nodes 1-1 to 1-4 can be constructed by, for example, a PC or a server. The hardware configurations of the distributed processing nodes 1-1 to 1-4 are described later.

In this embodiment, the distributed processing nodes 1-1 to 1-4 are sometimes collectively referred to as “distributed processing node 1”.

### Data Structure

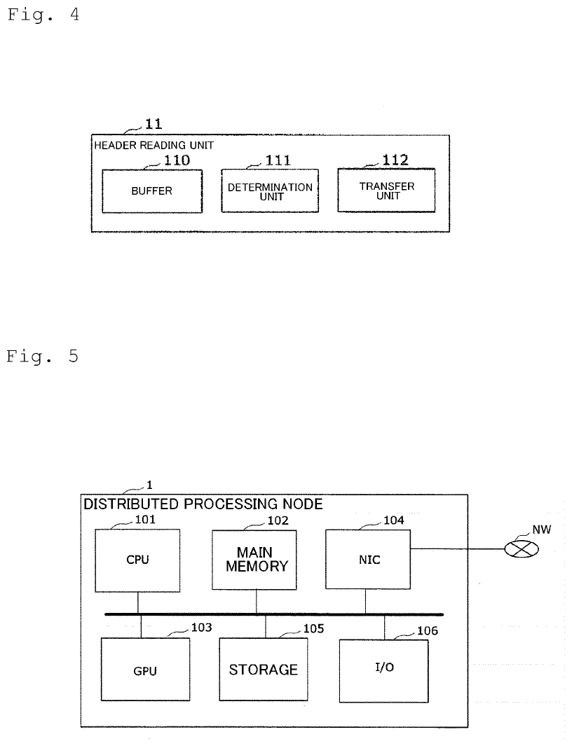

First, description is given of a structure of data to be transferred by the plurality of distributed processing nodes 1-1 to 1-4 according to this embodiment with reference to FIG. 3. In the distributed deep learning system according to this embodiment, any one of the distributed processing nodes 1-1 to 1-4 serves as a start point to start transfer of data. Data to be transmitted in the distributed deep learning system is transmitted in units of data frame, and for example, a data frame having an MTU in which the maximum payload of the data frame is 1500 bytes can be adopted.

As illustrated in FIG. 3, the data frame has a header and a packet (data). The header stores, in a field F1 specified in advance, layer information indicating which layer of a neural network to be learned the packet belongs to. For example, as the layer information, identification information set in advance to each layer of the neural network to be learned is stored. With this layer information, when a plurality of data frames are compared with each other, it is possible to determine whether a packet included in a data frame to be compared is a packet that belongs to a layer closer to the input layer or a packet that belongs to a layer closer to the output layer.

The packet included in a data frame includes, for example, a result of backpropagation calculation. Specifically, updated weight parameters in divided pieces of learning data of the neural network are included. Furthermore, results of gradient calculation and aggregation processing performed by each of the distributed processing nodes 1-1 to 1-4 are reflected in the packet.

The data frame has a format that depends on the specifications of the communication network NW adopted for the distributed deep learning system as long as the data frame can store layer information in the header in advance.

### Functional Blocks of a Distributed Processing Node

As illustrated in FIG. 1, the distributed processing node 1 includes a reception unit 10, a header reading unit 11, a sample input unit 12, a calculation unit 13, and a transmission unit 16. Each of the plurality of distributed processing nodes 1-1 to 1-4 included in the distributed deep learning system has a similar configuration.

The reception unit 10 receives a data frame transmitted from the outside such as the adjacent distributed processing node 1 or an external higher-order node, which is not shown. For example, the reception unit 10 receives a plurality of data frames in order of arrival of the data frames. In the example of FIG. 1, the reception unit 10 sequentially receives a first data frame p01 and then a second data frame p02 that has arrived next in order of transmission via the communication network NW. The first data frame p01 is, for example, any data frame among the plurality of data frames sequentially received by the reception unit 10, and the second data frame p02 is a data frame received immediately after the first data frame poi.

The header reading unit 11 buffers the first data frame p01 received by the reception unit 10. Furthermore, the header reading unit 11 reads layer information included in the header in order from the second data frame p02.

As illustrated in FIG. 4, the header reading unit 11 includes a buffer no, a determination unit in, and a transfer unit 112. Furthermore, as illustrated in FIG. 1, a transfer path TP is provided between the header reading unit 11 and the transmission unit 16.

The buffer no buffers the first data frame p01 received first by the reception unit 10.

The determination unit 111 reads layer information included in the header of the first data frame p01 temporarily held by the buffer no and layer information included in the header of the second data frame p02 received next. The determination unit 111 compares the pieces of layer information included in the read two data frames poi and pot with each other, and determines which one of these data frames is a data frame including a packet that belongs to a layer closer to the input layer. That is, the determination unit 111 determines which one of the two data frames poi and pot is a data frame closer to the input layer, and which one of the two data frames poi and pot is a data frame closer to the output layer.

The transfer unit 112 transfers the data frame closer to the input layer to the calculation unit 13 based on the result of determination by the determination unit 111. Furthermore, the transfer unit 112 transfers the data frame closer to the output layer to the transmission unit 16 via the transfer path TP based on the determination result. In this case, the calculation unit 13 of its own node skips calculation processing for the data frame closer to the output layer.

The sample input unit 12 inputs sample data into the calculation unit 13. The sample data is a result of forward propagation calculation used by the calculation unit 13. The sample input unit 12 reads, from an external memory, which is not shown, sample data corresponding to the data frame transferred to the calculation unit 13, and inputs the sample data into the calculation unit 13.

The calculation unit 13 includes a gradient calculation unit 14 and an aggregation processing unit 15.

The gradient calculation unit 14 calculates, for each sample data, the gradient of a loss function of the neural network with respect to each weight included in the data frame based on the data frame transferred by the transfer unit 112 and the sample data indicating the result of forward propagation calculation input by the sample input unit 12. The calculation unit 13 of each of the distributed processing nodes 1-1 to 1-4 performs gradient calculation processing for each piece of different sample data.

The aggregation processing unit 15 generates, for each weight, a value obtained by aggregating gradients for respective pieces of sample data calculated by the gradient calculation unit 14, and holds the value. Specifically, the aggregation processing unit 15 adds up the gradients calculated for respective pieces of sample data, and holds the calculation result for each weight.

The transmission unit 16 transmits, to the distributed processing node 1 at a subsequent stage via the communication network NW, the data frame transferred by the transfer unit 112 included in the header reading unit 11 and the data frame subjected to the gradient calculation processing and the aggregation processing in the node by the calculation unit 13. The transmission unit 16 performs transmission processing in order of transfer of the data frame. Thus, in some cases, the data frame is transmitted to the distributed processing node 1 at a subsequent stage in an order different from the order of reception of data frames by the reception unit 10.

In this manner, the result of each distributed processing node 1 performing gradient calculation and aggregation processing in the node is transferred to other distributed processing nodes 1, similar calculation processing is performed, the results of learning by respective distributed processing nodes 1 in a divided manner are aggregated through, for example, addition and averaging, and the value is distributed and shared by each distributed processing node 1 again.

### Hardware Configuration of a Distributed Processing Node

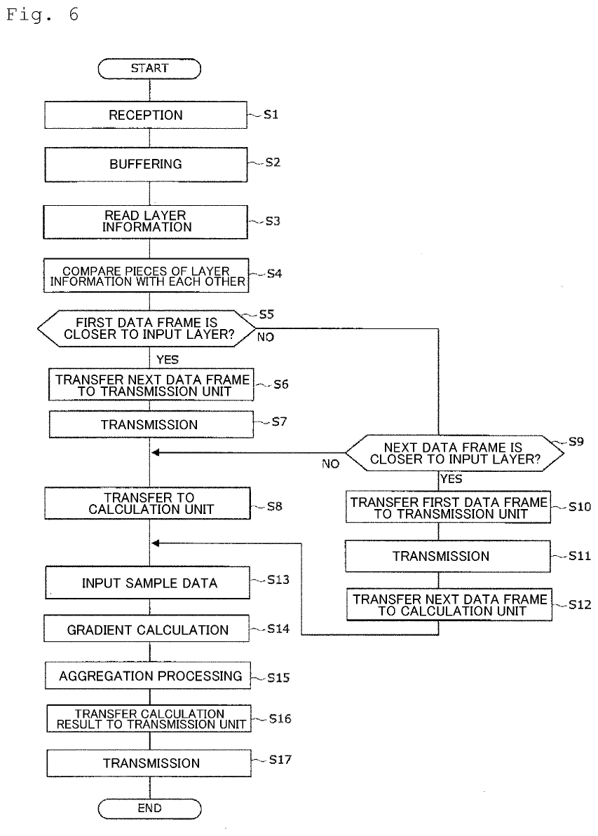

Next, description is given of the hardware configuration of the above-mentioned distributed processing node 1 with reference to FIG. 5.

As illustrated in FIG. 5, the distributed processing node 1 can be implemented by, for example, a computer including a CPU 101, a main memory 102, a GPU 103, a NIC 104, a storage 105, and an I/O 106, and a program that controls these hardware resources.

The main memory 102 stores in advance programs for the CPU 101 and the GPU 103 to perform various kinds of control and calculation. The CPU 101, the GPU 103, and the main memory 102 implement each function of the distributed processing node 1 such as the header reading unit 11, the gradient calculation unit 14, and the aggregation processing unit 15 illustrated in FIG. 1.

The NIC 104 is an interface circuit for connecting the distributed processing nodes 1 and various kinds of external electronic devices to one another via a network. The NIC 104 implements the reception unit 10 and the transmission unit 16 of FIG. 1.

The storage 105 is constructed by a readable/writable storage medium and a drive device for reading/writing various kinds of information such as a program and data from/to the storage medium. As the storage 105, a semiconductor memory such as a hard disk or a flash memory can be used as the storage medium.

The storage 105 has a program storage area that stores programs for the distributed processing node 1 to perform distributed processing including the processing of transferring data, the gradient calculation processing, and the aggregation processing. The storage 105 may have, for example, a backup area for taking backups of, for example, the above-mentioned data and program.

The I/O 106 is constructed by an I/O terminal that receives input of a signal from an external device or outputs a signal to the external device.

### Operation of Distributed Deep Learning System

Next, description is given of an operation of the distributed processing node 1 having the above-mentioned configuration with reference to the flow chart of FIG. 6.

First, the reception unit 10 receives a data frame transmitted from the distributed processing node 1 at an adjacent previous stage, for example, via the communication network NW (Step S1). The reception unit 10 receives a plurality of data frames in order of arrival thereof, that is, in order of the first data frame p01 and the second data frame p02 as illustrated in FIG. 1, for example.

Next, the buffer no included in the header reading unit 11 buffers the first data frame poi received first (Step S2). Next, the header reading unit 11 reads layer information stored in the field F1 of the header of each of the first data frame p01 temporarily held by the buffer no and the second data frame p02 received subsequent to the first data frame p01 (Step S3).

Next, the determination unit 111 compares the pieces of layer information of the two data frames read in Step S3 with each other (Step S4). The layer information is information indicating which layer of the neural network the packet included in the data frame belongs to.

Next, when the determination unit 111 determines that the first data frame poi received first is closer to the input layer than the second data frame p02 (Step S5: YES), the transfer unit 112 transfers the second data frame p02 closer to the output layer to the transmission unit 16 via the transfer path TP (Step S6). After that, the transmission unit 16 transmits the second data frame p02 to the distributed processing node 1 at a subsequent stage via the communication network NW (Step S7). After that, the transfer unit 112 transmits the first data frame p01 closer to the input layer to the calculation unit 13 (Step S8).

On the other hand, in Step S5, when it is determined that the first data frame poi received first is closer to the output layer (Step S5: NO) and the second data frame p02 received next is closer to the input layer (Step S9: YES), the transfer unit 112 transfers the first data frame poi closer to the output layer to the transmission unit 16 via the transfer path TP (Step S10). After that, the transmission unit 16 transmits the first data frame p01 to the distributed processing node 1 at a subsequent stage via the communication network NW (Step S11). After that, the transfer unit 112 transfers the second data frame p02 closer to the input layer to the calculation unit 13 (Step S12).

In Step S9, when the determination unit 111 determines that the first data frame poi and the second data frame p02 are pieces of data that belong to the same layer (Step S9: NO), the transfer unit 112 transfers the first data frame p01 to the calculation unit 13, and then transfers the second data frame p02 to the calculation unit 13 (Step S8). In this case, the first data frame p01 and the second data frame p02 are subjected to gradient calculation and aggregation processing by its own node in order of reception thereof, for example.

Next, following Step S8 or Step S12, when the transfer unit 112 has transferred a data frame to the calculation unit 13, the sample input unit 12 reads sample data from the external memory, and inputs the sample data into the calculation unit 13 (Step S13). After that, the gradient calculation unit 14 calculates, for each sample data, the gradient of the loss function of the neural network with respect to each weight included in the data frame to be subjected to calculation (Step S14).

Next, the aggregation processing unit 15 generates, for each weight, a value obtained by aggregating gradients for respective pieces of sample data calculated by the gradient calculation unit 14, and holds the value (Step S15).

After that, the calculation result obtained by the aggregation processing unit 15 is transferred to the transmission unit 16 (Step S16). After that, the transmission unit 16 transmits, to the distributed processing node 1 at a subsequent stage, a data frame including a packet indicating the results of calculating the gradient of the data frame closer to the input layer and aggregating the gradients in the node (Step S17).

Each of the plurality of distributed processing nodes 1-1 to 1-4 performs the processing from Step S1 to Step S17 in a similar manner. For example, in Step S9, when the distributed processing node 1-1 has transmitted a data frame closer to the output layer to the distributed processing node 1-2 at a subsequent stage, the distributed processing node 1-2 performs gradient calculation and aggregation processing for that data frame. When the distributed processing node 1-2 to which the data frame has been transferred after calculation processing is skipped already has a data frame closer to the input layer, the transferred data frame may be transferred to the distributed processing node 1-3 at a further subsequent stage. In this manner, returning of Allreduce processing is finished from the input layer side in the entire distributed deep learning system.

As described above, according to the first embodiment, each of the plurality of distributed processing nodes 1-1 to 1-4 connected to one another in a ring form included in the distributed deep learning system compares pieces of layer information of the first frame received first and the second data frame received next with each other. Then, each of the plurality of distributed processing nodes 1-1 to 1-4 determines which one of these data frames is a data frame including a packet that belongs to a layer closer to the input layer or the output layer. The transfer unit 112 transfers, to the transmission unit 16, a data frame determined to include a packet that belongs to a layer closer to the output layer, and skips gradient calculation by its own node and aggregation processing in the node.

According to this embodiment, when it is not necessary to perform calculation with sample data input by the sample input unit 12, gradient calculation and aggregation processing are not performed by its own node, and thus it is possible to reduce the latency of movement of data from the reception unit 10 to the transmission unit 16 in each distributed processing node 1. As a result, the latency of data transfer in the entire distributed deep learning system is reduced more, and distributed learning is performed more efficiently.

### Second Embodiment

Next, description is given of a second embodiment of the present invention. In the following description, the same components as those of the first embodiment described are assigned with the same reference numerals, and description thereof is omitted here.

The first embodiment relates to an exemplary case in which, for example, an Ethernet frame having a communication traffic in which the maximum payload is, for example, 1500 bytes is used as a data frame to be processed by each distributed processing node 1. In contrast, in the second embodiment, a jumbo frame having a frame size larger than the size of the data frame used in the first embodiment is used.

The configurations of the distributed processing node 1 and the distributed deep learning system according to this embodiment are similar to those of the first embodiment.

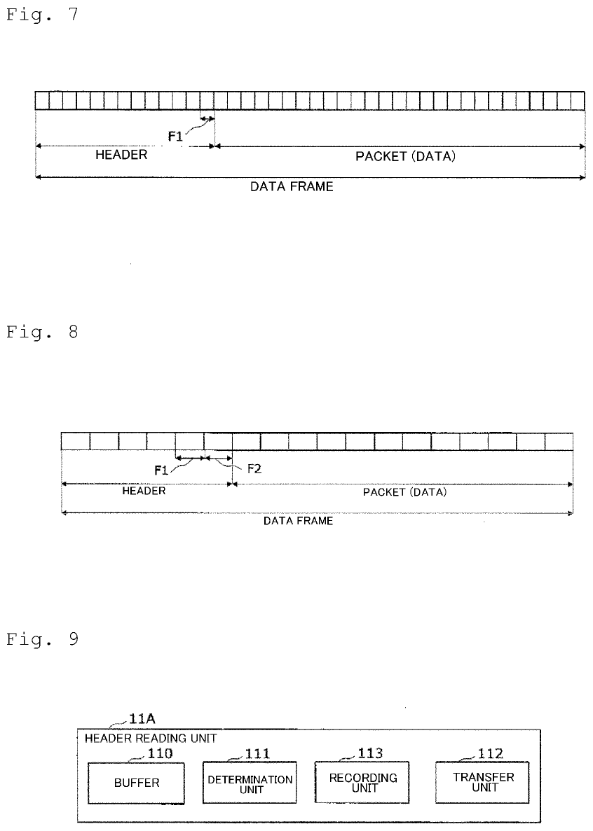

FIG. 7 is a schematic diagram for describing the structure of a data frame according to this embodiment. For example, the frame size of the data frame according to this embodiment is a data frame to which the communication traffic in which the maximum payload exceeds 1500 bytes is set. More specifically, a jumbo frame enlarged to have a frame size that enables storage of data equivalent to one layer of the neural network can be used.

Furthermore, as illustrated in FIG. 7, similarly to the data frame of the first embodiment, the specified field F1 of the header of the jumbo frame used in this embodiment also stores layer information indicating which layer of the neural network the packet of the data frame belongs to.

In this manner, in the second embodiment, a jumbo frame that can transfer data equivalent to one layer as a packet is used as a data frame to be processed and transferred in each distributed processing node 1. Thus, when pieces of layer information of data frames are compared with each other in the header reading unit 11, Allreduce processing for a layer closer to the input layer is finished more rapidly without causing comparison between data frames of the same layer.

### Third Embodiment

Next, description is given of a third embodiment of the present invention. In the following description, the same components as those of the first and second embodiments described above are assigned with the same reference numerals, and description thereof is omitted here.

In the first and second embodiments, description is given of a case in which the specified field F1 of the header of the data frame to be processed in the distributed processing node 1 stores layer information indicating which layer of the neural network the packet of the data frame belongs to. In contrast, in the third embodiment, the header of the data frame further describes node information indicating a node for which gradient calculation and aggregation processing for packets are skipped first among the plurality of distributed processing nodes 1-1 to 1-4. In the third embodiment, comparison determination processing for two sequentially received data frames is performed based on the layer information and node information of the header.

The overall configuration of the distributed processing node 1 according to this embodiment is similar to that of the first embodiment described above with reference to FIG. 1. The configuration of the distributed deep learning system is also similar to the system configuration of FIG. 2 described in the first embodiment. Now, description is mainly given of a configuration different from those of the first embodiment and the second embodiment.

### Data Structure

FIG. 8 is a schematic diagram for describing the structure of a data frame according to this embodiment. As illustrated in FIG. 8, the data frame to be transferred among the distributed processing nodes 1-1 to 1-4 has a header and a packet. The specified field F1 of the header stores layer information indicating which layer of the neural network the data of the packet belongs to. Furthermore, another field F2 of the header stores node information indicating for which node among the plurality of distributed processing nodes 1-1 to 1-4 gradient calculation and aggregation processing in the node are skipped first. For example, the field F2 stores identification information such as a node number of the distributed processing nodes 1-1 to 1-4 for which gradient calculation and aggregation processing are skipped first.

### Functional Blocks of Header Reading Unit

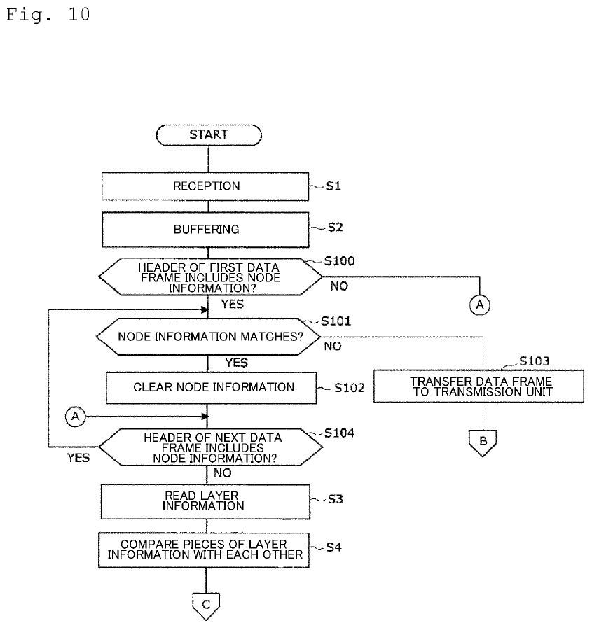

FIG. 9 is a block diagram illustrating the configuration of a header reading unit 11A according to this embodiment. The header reading unit 11A includes the buffer 110, the determination unit 111, the transfer unit 112, and a recording unit (first recording unit) 113.

The transfer unit 112 transfers a data frame storing node information indicating a node other than the own node in the field F2 of the header to the transmission unit 16 via the transfer path TP. Furthermore, similarly to the first embodiment, the transfer unit 112 transfers, to the calculation unit 13, a data frame determined to be a data frame closer to the input layer as a result of comparison of layer information by the determination unit 111.

The recording unit 113 stores identification information on the own node into the header of the data frame for which gradient calculation and aggregation processing in the own node are skipped in accordance with the result of determination by the determination unit 111. For example, the recording unit 113 stores the node number of the own node into the field F2 of the header illustrated in FIG. 8.

The recording unit 113 stores the node information indicating the own node into the field F2 of the header, so that gradient calculation and aggregation processing in the node are skipped in the other distributed processing nodes 1-2 to 1-4 at a subsequent stage connected to the communication network NW. Then, when the data frame for which the own node has first skipped calculation processing has returned to the own node again, the recording unit 113 clears node information indicating the own node of the header. The data frame for which the node information on the own node has been cleared is subjected to comparison and determination of layer information by the determination unit in, and then gradient calculation and aggregation processing are executed in the own node.

### Operation of Distributed Deep Learning System

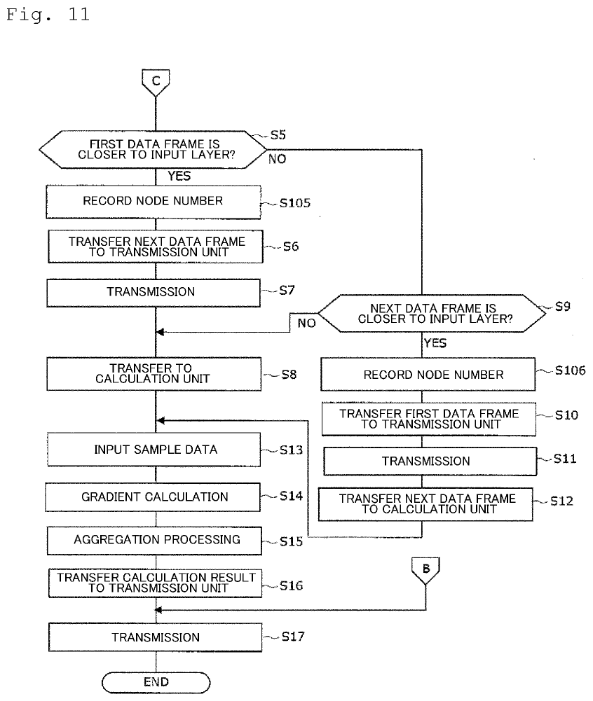

Next, description is given of an operation of a distributed learning system having the above-mentioned configuration. First, description is given of an operation of the distributed processing node 1 with reference to the flow charts of FIG. 10 and FIG. 11.

First, as illustrated in FIG. 10, the reception unit 10 receives a data frame from the outside, for example, via the communication network NW (Step S1). The reception unit 10 sequentially receives a plurality of data frames, and for example, as illustrated in FIG. 1, the reception unit 10 receives data frames in order of the first data frame p01 and the second data frame p02.

Next, the buffer no buffers the first data frame p01 received first (Step S2). Next, when node information is stored in the field F2 of the header of the first data frame p01 (Step S100: YES) and the node information indicates another node other than the own node (Step S101: NO), the transfer unit 112 transfers the first data frame p01 received first to the transmission unit 16 via the transfer path TP (Step S103).

After that, the processing transitions to Step S17 of FIG. 11 via a connector B, and the transmission unit 16 transmits the first data frame p01 to the distributed processing node 1 at a subsequent stage (Step S17). In this manner, the first data frame p01 in which the node information indicating a node other than the own node is stored in the header is transferred to the distributed processing node 1 at a subsequent stage before layer information of the header is read in each distributed processing node 1.

On the other hand, in Step S101, when the node information included in the header of the first data frame p01 received first matches the node information of the own node (Step S101: YES), the recording unit 113 clears the node information of the header of the first data frame p01 (Step S102). For example, such processing is executed when a data frame for which gradient processing and aggregation processing are skipped first in the own node has returned to the own node again. After that, the processing transitions to Step S104.

In Step S100, when the header of the first data frame p01 received first does not store node information (Step S100: NO), the processing transitions to Step S104 via a connector A. Next, when the header of a second frame received immediately after the first data frame p01 in which node information is not stored in the header also does not store node information (Step S104: NO), the determination unit 111 reads pieces of layer information of the headers of the second data frame p02 and the first data frame p01 (Step S3). The determination unit 111 compares the read pieces of layer information of the two data frames with each other (Step S4). After that, the processing transitions to Step S5 of FIG. 11 via a connector C.

On the other hand, in Step S104, when the header of the second data frame p02 received next stores node information (Step S104: YES), the processing transitions to Step S101. When the node information matches the own node (Step S101: YES), the header information of the header is cleared (Step S102).

Next, as a result of comparison of layer information in Step S4, when the determination unit 111 has determined that the first data frame p01 received first is closer to the input layer (Step S5: YES), the recording unit 113 stores node information indicating the own node into the field F2 of the header of the other second data frame p02 closer to the output layer (Step S105). Next, the transfer unit 112 transfers the second data frame p02 to the transmission unit 16 via the transfer path TP (Step S6). After that, the transmission unit 16 transmits, to the distributed processing node 1 at a subsequent stage, the second data frame p02 in which node information indicating the own node is recorded in the header (Step S7).

On the other hand, in Step S5, when the determination unit 111 has determined that the first data frame p01 received first is closer to the output layer (Step S5: NO) and the second data frame p02 received next is closer to the input layer (Step S9: YES), the recording unit 113 stores node information indicating the own node into the header of the first data frame poi closer to the output layer (Step S106).

Next, the transfer unit 112 transfers the first data frame p01 in which node information is stored in the header to the transmission unit 16 via the transfer path TP (Step S10). After that, the transmission unit 16 transmits the first data frame p01 in which node information is stored in the header to the distributed processing node 1 at a subsequent stage via the communication network NW (Step S11). After that, the transfer unit 112 transfers the second data frame p02 closer to the input layer to the calculation unit 13 (Step S12).

In Step S9, when the determination unit iii has determined that the first data frame poi and the second data frame p02 are pieces of data that belong to the same layer (Step S9: NO), the transfer unit 112 transfers the first data frame p01 to the calculation unit 13, and after that, transfers the second data frame p02 to the calculation unit 13 (Step S8). In this case, the first data frame p01 and the second data frame p02 are subjected to gradient calculation and aggregation processing in the own node in order of reception thereof.

Next, following Step S8 or Step S12, when the transfer unit 112 has transferred a data frame to the calculation unit 13, the sample input unit 12 reads sample data from an external memory, and inputs the sample data into the calculation unit 13 (Step S13). After that, the gradient calculation unit 14 calculates, for each sample data, the gradient of the loss function of the neural network with respect to each weight included in the data frame to be subjected to calculation (Step S14).

Next, the aggregation processing unit 15 generates, for each weight, a value obtained by aggregating gradients for respective pieces of sample data calculated by the gradient calculation unit 14, and holds the value (Step S15).

After that, the calculation result obtained by the aggregation processing unit 15 is transferred to the transmission unit 16 (Step S16). After that, the data frame of packets including a packet indicating the results of calculating the gradient of the data frame closer to the input layer and aggregating the gradients in the node is transmitted from the transmission unit 16 to the distributed processing node 1 at a subsequent stage (Step S17).

FIG. 12 is a block diagram illustrating an example of an operation of the distributed deep learning system according to this embodiment. As illustrated in FIG. 12, a case in which data frames p1 to p6 are generated in the distributed processing node 1-1 is considered. Furthermore, as illustrated in FIG. 12, it is assumed that the data frame p6 is a data frame including a packet that belongs to a layer closest to the input layer, and the data frame p1 includes a packet that belongs to a layer closest to the output layer.

The data frames p1 to p6 generated in the distributed processing node 1-1 are subjected to gradient calculation using sample data input from the sample input units 12 of the distributed processing nodes 1-2 and 1-3 and aggregation processing in the node. When processing is finished in all of the distributed processing nodes 1-1 to 1-4, calculation is finished.

For example, the distributed processing node 1-2 first compares pieces of layer information of the data frame p1 received first and the data frame p2 received next with each other. In the distributed processing node 1-2, the data frame p2 closer to the input layer is subjected to gradient processing and aggregation processing in the node, and then is transmitted to the distributed processing node 1-3 at a subsequent stage. On the other hand, the header of the data frame p1 closer to the output layer stores node information such as the node number of the distributed processing node 1-2, and gradient calculation and aggregation processing in the distributed processing node 1-2 are skipped. Gradient calculation and aggregation processing are skipped also in the subsequent distributed processing nodes 1-3, 1-4, and 1-1.

After that, any one of the following processing (1) to (5) occurs. Which processing occurs depends on a time at which the data frame p1 returns to the distributed processing node 1-1.

(1) In the distributed processing node 1-2, comparison of pieces of layer information of the data frame p1 and the data frame p4 occurs. The data frame p4 closer to the input layer is subjected to gradient calculation and aggregation processing in the distributed processing node 1-2, and is transmitted to the adjacent distributed processing node 1-3. On the other hand, the processing of the data frame p1 closer to the output layer is skipped in the distributed processing nodes 1-3 to 1-1 after the distributed processing node 1-2.

(2) In the distributed processing node 1-3, comparison of pieces of layer information of the data frame p2 and the data frame p3 occurs. The data frame p3 closer to the input layer is subjected to gradient calculation and aggregation processing in the distributed processing node 1-3, and is transmitted to the adjacent distributed processing node 1-4. On the other hand, the processing of the data frame p2 closer to the output layer is skipped in the distributed processing nodes 1-4 to 1-2 after the distributed processing node 1-3.

(3) In the distributed processing node 1-2, comparison of pieces of layer information of the data frame p1 and the data frame p5 occurs. The data frame p5 closer to the input layer is subjected to gradient calculation and aggregation processing in the distributed processing node 1-2, and is transmitted to the adjacent distributed processing node 1-3. On the other hand, the processing of the data frame p1 closer to the output layer is skipped in the distributed processing nodes 1-3 to 1-1 after the distributed processing node 1-2.

(4) In the distributed processing node 1-3, comparison of pieces of layer information of the data frame p2 and the data frame p4 occurs. The data frame p4 closer to the input layer is subjected to gradient calculation and aggregation processing in the distributed processing node 1-3, and is transmitted to the adjacent distributed processing node 1-4. On the other hand, the processing of the data frame p2 closer to the output layer is skipped in the distributed processing nodes 1-4 to 1-2 after the distributed processing node 1-3.

(5) In the distributed processing node 1-4, comparison of pieces of layer information of the data frame p3 and the data frame p4 occurs. The data frame p4 closer to the input layer is subjected to gradient calculation and aggregation processing in the distributed processing node 1-4, and calculation is finished. On the other hand, the processing of the data frame p3 closer to the output layer is skipped in the distributed processing node 1-4.

Similar processing is performed for each data frame, and calculation is finished in order of the data frames p4, p5, p6, p3, p2, and p1. In this manner, returning of Allreduce processing can be finished from data on the input layer side preferentially.

As described above, according to the third embodiment, layer information and information on a node for which gradient calculation and aggregation processing in the node are skipped first are recorded in the header of the data frame. Thus, in the distributed processing node 1, when calculation using sample data input from the sample input unit 12 is not required, gradient calculation and aggregation processing in the node are skipped for the node for which calculation is not required, and thus latency of movement of data from the reception unit 10 to the transmission unit 16 is reduced, and calculation can be finished preferentially from data closer to the input layer.

### Fourth Embodiment

Next, description is given of a fourth embodiment of the present invention. In the following description, the same components as those of the first to third embodiments described above are assigned with the same reference numerals, and description thereof is omitted here.

The third embodiment describes a case in which the header of a data frame records node information indicating for which one of the distributed processing nodes 1-1 to 1-4 gradient calculation and aggregation processing in the node are skipped first. In contrast, in a fourth embodiment, the header of a data frame describes status information indicating a calculation execution status for each of the distributed processing nodes 1-1 to 1-4, which indicates whether gradient calculation and aggregation processing are already executed or skipped in each of the distributed processing nodes 1-1 to 1-4.

### Data Structure

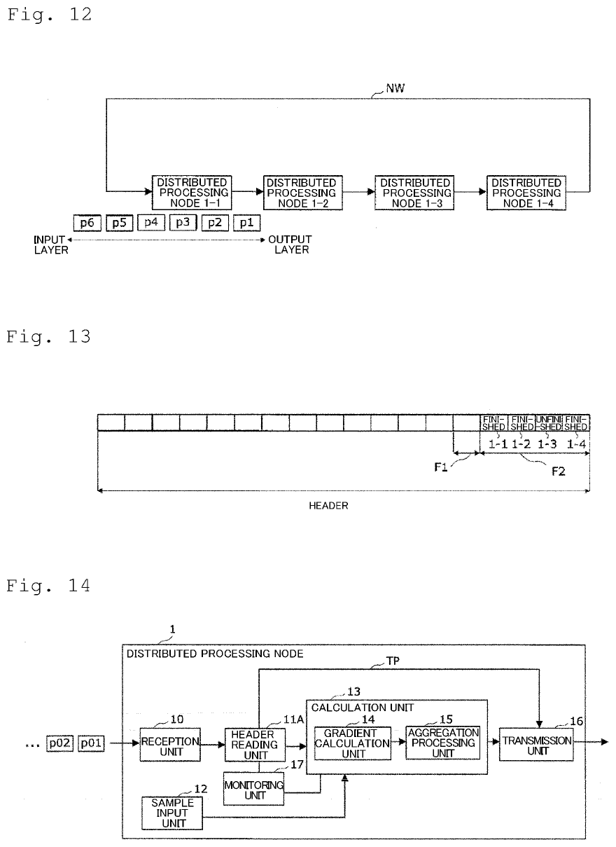

FIG. 13 is a schematic diagram for describing the structure of the header of a data frame according to this embodiment. As illustrated in FIG. 13, the field F1 of the header stores layer information indicating which layer of the neural network the data of a packet belongs to. Furthermore, the field F2 stores a value indicating a calculation execution status of each of the distributed processing nodes 1-1 to 1-4 into a region allocated to each of the distributed processing nodes 1-1 to 1-4.

In the example of FIG. 13, the regions allocated to the distributed processing nodes 1-1 and 1-2 each store a value “finished” indicating that gradient calculation and aggregation processing in the node are already executed for a data frame. On the other hand, the region allocated to the distributed processing node 1-3 stores a value “unfinished” indicating that gradient calculation and aggregation processing are skipped. However, the region allocated to the distributed processing node 1-4 stores a value “finished” indicating that gradient calculation and aggregation processing are already executed.

In both of a case in which gradient calculation and aggregation processing in the node are executed and a case in which gradient calculation and aggregation processing in the node are skipped, the recording unit 113 of each of the distributed processing nodes 1-1 to 1-4 stores, into a region allocated to the header of the data frame, any one of the value “unfinished” indicating that the processing has been skipped or the value “finished” indicating that the processing has been executed as status information.

### Functional Blocks of Distributed Processing Node

FIG. 14 is a block diagram illustrating an example of the functional blocks of the distributed processing node 1 according to this embodiment. As illustrated in FIG. 14, the configuration of the distributed processing node 1 according to this embodiment is different from the configuration of the distributed processing node 1 according to the third embodiment in that the distributed processing node 1 according to this embodiment further includes a monitoring unit 17.

The monitoring unit 17 monitors whether or not the calculation unit 13 has a capacity for calculation processing. When the calculation unit 13 has a capacity for gradient calculation and aggregation processing in the node, the monitoring unit 17 inputs a notification signal to the recording unit (second recording unit and third recording unit) 113.

When the recording unit 113 has received a notification signal from the monitoring unit 17, the recording unit 113 records the value “finished” into a region allocated to the field F2 of the header of the data frame held in the buffer 110. In this case, the calculation unit 13 executes gradient calculation and aggregation processing in the node for the data frame.

For example, even in a case where the first data frame p01 received first is a transferred data frame for which gradient calculation and aggregation processing are skipped in the distributed processing node 1 at a previous stage and has not yet returned to the distributed processing node 1 that has skipped the calculation processing again, when the distributed processing node 1 to which the first data frame p01 is transferred has a capacity for calculation processing, the calculation unit 13 to which the first data frame p01 is transferred executes the calculation processing.

Furthermore, similarly to the third embodiment, when gradient calculation by its own node and aggregation processing in the node are skipped, the recording unit 113 records the value “unfinished” indicating that the calculation processing by its own node is not executed yet into a predetermined region of the header.

As described above, according to the fourth embodiment, status information indicating a calculation execution status of each of the distributed processing nodes 1-1 to 1-4 is stored in the header. Thus, even in a case where the data frame is a data frame for which calculation processing is skipped in a certain distributed processing node 1, when the data frame can be processed in the distributed processing node 1 at a subsequent stage, gradient calculation and aggregation processing are executed. Thus, it is possible to cause the distributed processing node 1 having a capacity for calculation to perform calculation, and reduce the Allreduce processing period more.

In the above-mentioned embodiments, the distributed deep learning system includes the plurality of distributed processing nodes 1-1 to 1-4 as an example. However, for example, the distributed deep learning system may be connected to a higher-order processing node, which is not shown, via the communication network NW.

In the above, the distributed deep learning system and data transfer method according to embodiments of the present invention have been described, but the present invention is not limited to the above-mentioned embodiments. Various kinds of modifications that may be assumed by a person skilled in the art can be made within the range of the invention described in the appended claims.

### REFERENCE SIGNS LIST

1, 1-1, 1-2, 1-3, 1-4 Distributed processing node
10 Reception unit
11 Header reading unit
12 Sample input unit
13 Calculation unit
14 Gradient calculation unit
15 Aggregation processing unit
16 Transmission unit
110 Buffer
111 Determination unit
112 Transfer unit
101 CPU
102 Main memory
103 GPU
104 NIC
105 Storage
106 I/O
NW Communication network

1-7. (canceled)

8. A distributed deep learning system configured to perform forward propagation calculation and backpropagation calculation based on learning data of a neural network repetitively in a distributed manner in units of data frame and to perform collective communication of adding up calculation results of the backpropagation calculation, the distributed deep learning system comprising:
a plurality of distributed processing nodes defining a ring communication network that enables communication in one direction, wherein each of the plurality of distributed processing nodes comprises:
a receiver configured to sequentially receive, via the ring communication network, a first data frame that has arrived at an own node and a second data frame that has arrived at the own node subsequent to the first data frame;
a header reader configured to read layer information included in a header of each of the first data frame and the second data frame received by the receiver, which indicates which layer of a plurality of layers of the neural network data included in each of the first data frame and the second data frame belongs to, the plurality of layers comprising an input layer, an intermediate layer, and an output layer;
a determiner configured to compare the layer information read by the header reader from the first data frame received by the receiver with the layer information read from the second data frame received subsequent to the first data frame and to determine whether a layer of data of the first data frame is closer to the input layer or the output layer and whether a layer of data of the second data frame is closer to the input layer or the output layer;
a calculator configured to execute, based on a determination by the determiner, calculation processing based on input of sample data indicating a result of forward propagation calculation of the neural network for a data frame including data that belongs to a layer closer to the input layer out of the first data frame and the second data frame;
a transfer device configured to skip, based on the determination by the determiner, the calculation processing for a data frame including data that belongs to a layer closer to the output layer out of the first data frame and the second data frame; and
a transmitter configured to transmit, to a distributed processing node at a subsequent stage, the first data frame and the second data frame processed by the calculator or the transfer device, wherein the transmitter is configured to transmit, to the distributed processing node at the subsequent stage, a data frame for which the calculation processing has been skipped by the transfer device before a data frame for which the calculation processing has been executed by the calculator out of the first data frame and the second data frame.

9. The distributed deep learning system according to claim 8, wherein the calculator comprises:
a gradient calculator configured to calculate, for each sample data, a gradient with respect to a weight of the neural network; and
an aggregation processor configured to aggregate the gradients calculated by the gradient calculator.

10. The distributed deep learning system according to claim 9, wherein:
each of the plurality of distributed processing nodes further comprises a first recorder configured to record node information identifying the own node into a header of a data frame that is determined to be the data frame including data that belongs to a layer closer to the output layer by the determiner out of the first data frame and the second data frame; and
the transfer device is configured to skip the calculation processing for a data frame that records, in a header, node information indicating a distributed processing node other than the own node out of the received first data frame and the received second data frame.

11. The distributed deep learning system according to claim 9, wherein:
the header of each of the first data frame and the second data frame is configured to store the layer information and status information indicating whether or not the calculator of each of the plurality of distributed processing nodes has executed the calculation processing; and
each of the plurality of distributed processing nodes further comprises:
a second recorder configured to record the status information indicating that the calculator has not executed the calculation processing yet into a region that stores the status information allocated to a header of a data frame for which the transfer device skips the calculation processing out of the first data frame and the second data frame; and
a third recorder configured to record, based on the determination by the determiner, the status information indicating that the calculator has already executed the calculation processing into the region that stores the status information allocated to a header of a data frame for which the calculator executes the calculation processing out of the first data frame and the second data frame.

12. The distributed deep learning system according to claim 11, wherein:
each of the plurality of distributed processing nodes further comprises a monitor configured to monitor whether or not the gradient calculator is executing a calculation;
the third recorder is configured to record, when a signal indicating that the gradient calculator is not executing the calculation is input from the monitor, the status information indicating that the calculator has already executed the calculation processing into the region that stores the status information allocated to a header of a data frame received by the receiver; and
the calculator is configured to execute the calculation processing for the data frame into which the status information is recorded by the third recorder.

13. The distributed deep learning system according to claim 8, wherein the data frame has a frame size enabling transmission of learning data for each layer of the neural network.

14. A data transfer method to be executed by a distributed deep learning system comprising a plurality of distributed processing nodes forming a ring communication network that enables communication in one direction, the distributed deep learning system performing forward propagation calculation and backpropagation calculation based on learning data of a neural network repetitively in a distributed manner in units of data frame and performing collective communication of adding up calculation results of the backpropagation calculation, the data transfer method comprising:
a first step of sequentially receiving, via the communication network, a first data frame that has arrived at an own node and a second data frame that has arrived at the own node subsequent to the first data frame;
a second step of reading layer information included in a header of each of the first data frame and the second data frame received in the first step, which indicates which layer of a plurality of layers of the neural network data included in each of the first data frame and the second data frame belongs to, the plurality of layers comprising an input layer, an intermediate layer, and an output layer;
a third step of comparing the layer information read in the second step from the first data frame received in the first step with the layer information read from the second data frame received subsequent to the first data frame and determining which one of the input layer and the output layer a layer of data of each of the first data frame and the second data frame is closer to;
a fourth step of executing, based on a result of the determining in the third step, calculation processing based on input of sample data indicating a result of forward propagation calculation of the neural network for a data frame including data that belongs to a layer closer to the input layer out of the first data frame and the second data frame;
a fifth step of skipping, based on the result of the determining in the third step, the calculation processing for a data frame including data that belongs to a layer closer to the output layer out of the first data frame and the second data frame; and
a sixth step of transmitting, to a distributed processing node at a subsequent stage, the first data frame and the second data frame processed in the fourth step or the fifth step, wherein the sixth step comprises transmitting, to the distributed processing node at the subsequent stage, a data frame for which the calculation processing has been skipped in the fifth step before a data frame for which the calculation processing has been executed in the fourth step out of the first data frame and the second data frame.
